(19) United States
(12) Patent Application Publication
(10) Pub. No.: US 2026/0160680 A1
(43) Pub. Date: Jun. 11, 2026

(54) TERAHERTZ WAVE GENERATION DEVICE AND TERAHERTZ WAVE GENERATION METHOD

(71) Applicant: HAMAMATSU PHOTONICS K.K., Hamamatsu-shi (JP)

(72) Inventors: Hisanari TAKAHASHI, Shizuoka (JP); Kouichiro AKIYAMA, Shizuoka (JP); Kento TOUME, Shizuoka (JP); Hideaki SEUE, Shizuoka (JP); Naoya KAWAI, Shizuoka (JP)

(73) Assignee: HAMAMATSU PHOTONICS K.K., Hamamatsu-shi (JP)

(21) Appl. No.: 19/411,834

(22) Filed: Dec. 8, 2025

(30) Foreign Application Priority Data
Dec. 9, 2024 (JP) 2024-214226

(51) Int. Cl. G01N 21/3581

(52) U.S. Cl. CPC G01N 21/3581; G01N 2201/06113

(57) ABSTRACT

The terahertz wave generation apparatus 1 includes an oscillator 2 that oscillates ultra-short pulse light L, a fiber amplifier 3 that broadens the spectrum of the ultra-short pulse light L oscillated by the oscillator 2, a soliton shift fiber 6 that modulates the wavelength of the ultra-short pulse light L, the spectrum of which has been broadened by the fiber amplifier 3, using a soliton self-frequency shift, and an organic crystal 9 that generates a terahertz wave by being irradiated with the ultra-short pulse light L modulated by the soliton shift fiber 6.

### TECHNICAL FIELD

One aspect of the present disclosure relates to a terahertz wave generation apparatus.

### BACKGROUND

A pulse light generation apparatus is known, which includes an oscillation unit that oscillates pulse light and a modulation unit that modulates the wavelength of the pulse light oscillated by the oscillation unit using a soliton self-frequency shift. In such a pulse light generation apparatus, by increasing the intensity of the pulse light before modulation by the modulation unit, it is designed to split the pulse light into a plurality of pulse lights with different wavelengths (outputting multicolored solitons) through the modulation (see, for example, JP-A-2004-527001).

### SUMMARY

A technique is known in which a terahertz wave is generated by irradiating an organic crystal with pulse light output from a pulse light generation apparatus as described above, and the generated terahertz wave is detected. Here, in the pulse light generation apparatus described above, when the intensity of the pulse light before modulation by the modulation unit is increased, the pulse light may be split by the modulation to form a plurality of pulse lights (hereinafter also referred to as “multi-solitonization”). In this case, pulse splitting may also occur in the terahertz wave generated in a subsequent stage, which may hinder high-efficiency terahertz wave generation.

One aspect of the present disclosure has been made in view of the above circumstances, and an object thereof is to provide a terahertz wave generation apparatus and a terahertz wave generation method capable of generating a terahertz wave with high efficiency.

A terahertz wave generation apparatus of the present disclosure is [1] “a terahertz wave generation apparatus comprising: an oscillation unit that oscillates pulse light; a first amplification unit that broadens the spectrum of the pulse light oscillated by the oscillation unit; a modulation unit that modulates the wavelength of the pulse light, the spectrum of which has been broadened by the first amplification unit, using a soliton self-frequency shift; and a terahertz wave generation unit that generates a terahertz wave by being irradiated with the pulse light modulated by the modulation unit.”

As a result of intensive studies, the inventors have found that multi-solitonization can be suppressed by broadening the spectrum of the pulse light before performing modulation using a soliton self-frequency shift. Therefore, in the terahertz wave generation apparatus of the present disclosure, the spectrum of the pulse light is broadened, and the wavelength of the broadened pulse light is modulated using a soliton self-frequency shift. This makes it possible to suppress multi-solitonization even when, for example, the intensity of the pulse light before modulation is increased. By irradiating the terahertz wave generation unit with the pulse light in which multi-solitonization is suppressed, a terahertz wave can be generated without causing pulse splitting. This enables the generation of a terahertz wave with high efficiency.

The terahertz wave generation apparatus of the present disclosure may be [2] “the terahertz wave generation apparatus according to [1], wherein the terahertz wave generation unit is configured to include an organic crystal.” With such a configuration, it is possible to generate a terahertz wave with higher efficiency.

The terahertz wave generation apparatus of the present disclosure may be [3] “the terahertz wave generation apparatus according to [2], wherein the terahertz wave generation unit is configured to include at least one of DAST, DASC, and DSTMS as the organic crystal.” With such a configuration, it is possible to generate a terahertz wave with higher efficiency.

The terahertz wave generation apparatus of the present disclosure may be [4] “the terahertz wave generation apparatus according to any one of [1] to [3], wherein the terahertz wave generation unit generates the terahertz wave having a frequency in the range of 0.01 to 30 THz.” By being set to such a frequency band, absorption specific to terahertz waves increases, enabling appropriate spectroscopy.

The terahertz wave generation apparatus of the present disclosure may be [5] “the terahertz wave generation apparatus according to any one of [1] to [4], further comprising a second amplification unit configured to include a thulium-doped fiber amplifier that amplifies the pulse light modulated by the modulation unit, wherein the terahertz wave generation unit generates the terahertz wave by being irradiated with the pulse light modulated by the modulation unit and amplified by the second amplification unit.” By irradiating the terahertz wave generation unit with the pulse light amplified by the second amplification unit, it is possible to generate a terahertz wave with higher efficiency.

The terahertz wave generation apparatus of the present disclosure may be [6] “the terahertz wave generation apparatus according to any one of [1] to [5], further comprising a terahertz wave detection unit that detects the terahertz wave output from the terahertz wave generation unit.” By providing the terahertz wave detection unit in the terahertz wave generation apparatus, the terahertz wave generated with high efficiency can be detected easily and quickly.

The terahertz wave generation apparatus of the present disclosure may be [7] “the terahertz wave generation apparatus according to any one of [1] to [6], further comprising: an optical branching unit that branches the pulse light modulated by the modulation unit into pump light with which the terahertz wave generation unit is irradiated and probe light; an optical path delay unit that time-delays the probe light by changing the optical path length of the probe light; and a terahertz wave detection crystal into which the pump light with which a sample is irradiated and the probe light that has passed through the optical path delay unit are incident.” With such a configuration, the complex refractive index of a sample can be obtained using terahertz time-domain spectroscopy, and the state of the sample can be appropriately detected. Furthermore, by using the residual light component that did not contribute to terahertz wave generation as probe light for terahertz wave detection, light can be utilized without waste while efficiently detecting the terahertz wave.

The terahertz wave generation apparatus of the present disclosure may be [8] “the terahertz wave generation apparatus according to any one of [1] to [5], further comprising a terahertz wave measurement unit that measures the terahertz wave output from the terahertz wave generation unit, wherein the terahertz wave measurement unit is configured to include a photomultiplier tube having sensitivity in the band of light including the terahertz wave.” With such a configuration, the interference time waveform and spectrum of the terahertz wave generated efficiently can be measured quickly and efficiently.

The terahertz wave generation apparatus of the present disclosure may be [9] “the terahertz wave generation apparatus according to any one of [1] to [5], further comprising a terahertz wave measurement unit that measures the terahertz wave output from the terahertz wave generation unit, wherein the terahertz wave measurement unit is configured to include an image intensifier that converts the terahertz wave to electrons to acquire an image.” With such a configuration, the interference time waveform and spectrum image of the terahertz wave generated efficiently can be measured quickly and efficiently.

The terahertz wave generation method of the present disclosure may be [10] “a terahertz wave generation method including: oscillating pulse light; broadening the spectrum of the pulse light; modulating the wavelength of the broadened pulse light using a soliton self-frequency shift; and generating a terahertz wave by irradiating an organic crystal with the modulated pulse light.”

### BRIEF DESCRIPTION OF THE DRAWINGS

FIG. 1 is a block diagram showing a terahertz wave generation apparatus according to an embodiment.

FIG. 2(a) is a graph showing the time waveform of ultra-short pulse light output from the oscillator of FIG. 1. FIG. 2(b) is a graph showing the spectrum of ultra-short pulse light output from the oscillator of FIG. 1. FIG. 2(c) is a graph showing the time waveform of ultra-short pulse light output from the fiber amplifier of FIG. 1. FIG. 2(d) is a graph showing the spectrum of ultra-short pulse light output from the fiber amplifier of FIG. 1.

FIG. 3 is a graph showing a specific example of the spectrum of ultra-short pulse light output from the fiber amplifier of FIG. 1.

FIG. 4(a) is a graph showing the time waveform of ultra-short pulse light output from the acousto-optic modulator of FIG. 1. FIG. 4(b) is a graph showing the spectrum of ultra-short pulse light output from the acousto-optic modulator of FIG. 1.

FIG. 5(a) is a graph showing the time waveform of ultra-short pulse light output from the soliton shift fiber of FIG. 1. FIG. 5(b) is a graph showing the spectrum of ultra-short pulse light output from the soliton shift fiber of FIG. 1. FIG. 5(c) is a graph showing the time waveform of ultra-short pulse light output from a filter. FIG. 5(d) is a graph showing the spectrum of ultra-short pulse light output from a filter.

FIG. 6(a) is a graph showing the relationship between the intensity of ultra-short pulse light input to the soliton shift fiber, the wavelength of solitons, and the number of solitons. FIG. 6(b) is a graph showing the relationship between the spectral width of ultra-short pulse light input to the soliton shift fiber, the wavelength of solitons, and the number of solitons.

FIG. 7 is a diagram explaining terahertz wave generation.

FIG. 8 is a diagram explaining terahertz wave detection.

FIG. 9 is a flowchart showing an example of a terahertz wave generation and detection method.

FIG. 10 is a diagram explaining terahertz wave detection according to a modification.

FIG. 11 is a diagram explaining terahertz wave detection according to another modification.

FIG. 12 is a diagram showing an example of the configuration of a terahertz measurement unit.

### DETAILED DESCRIPTION

Hereinafter, embodiments will be described in detail with reference to the drawings. In each figure, the same or corresponding parts are denoted by the same reference numerals, and duplicate descriptions are omitted.

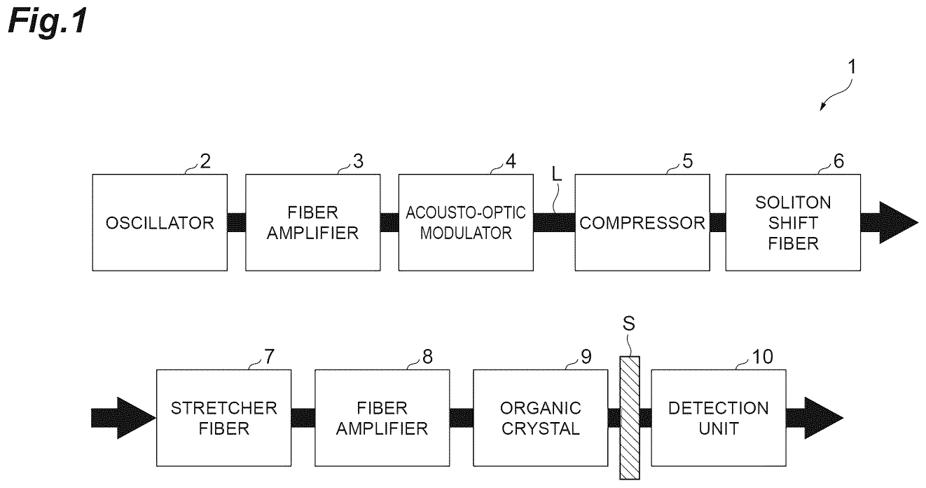

As shown in FIG. 1, a terahertz wave generation apparatus 1 according to the present embodiment generates long-wavelength ultra-short pulse light (pulse light) L using a soliton self-frequency shift (Raman soliton shift). The terahertz wave generation apparatus 1 includes an oscillator 2 (oscillation unit), a fiber amplifier 3 (first amplification unit), an acousto-optic modulator 4, a compressor 5, a soliton shift fiber 6 (modulation unit), a stretcher fiber 7, a fiber amplifier 8 (second amplification unit), an organic crystal 9 (terahertz wave generation unit), and a detection unit 10 (terahertz wave detection unit). The terahertz wave generation apparatus 1 functions as a wavelength-tunable laser apparatus, and its wavelength range may be 1500 nm to 4000 nm, average power may be 1 mW or more, repetition frequency may be 1 MHz or more, and pulse width may be 10 ps or less (e.g., 100 fs or less).

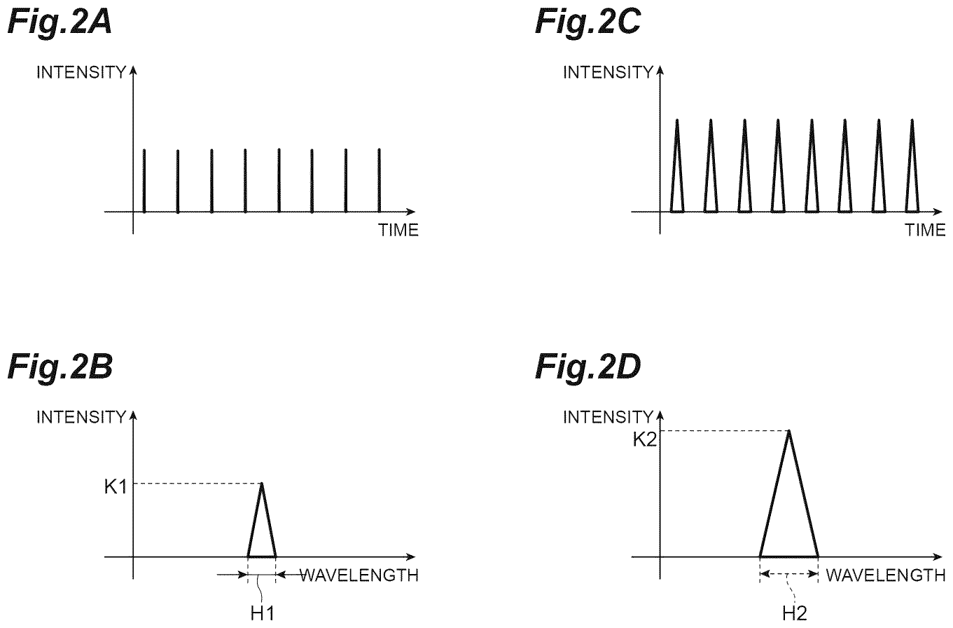

The oscillator 2 constitutes an oscillation unit that oscillates ultra-short pulse light L. As shown in FIG. 2(a), the oscillator 2 generates an ultra-short pulse train with a predetermined period. As shown in FIG. 2(b), the oscillator 2 oscillates ultra-short pulse light L having a spectrum with a first spectral width H1 and a first intensity K1. The oscillator 2 oscillates, for example, ultra-short pulse light L in a wavelength band of 1550 nm or less. The oscillator 2 is not particularly limited, and various oscillators can be used.

The fiber amplifier 3 constitutes an amplification unit that broadens the spectrum of the ultra-short pulse light L oscillated by the oscillator 2. The fiber amplifier 3 broadens the spectrum of the ultra-short pulse light L by similariton amplification and increases the output of the ultra-short pulse light L. The fiber amplifier 3 is disposed between the oscillator 2 and the soliton shift fiber 6 in the optical path of the ultra-short pulse light L.

The fiber amplifier 3 includes a fiber amplifier. The fiber amplifier of the fiber amplifier 3 is a normal dispersion fiber and is a double-clad fiber co-doped with erbium and ytterbium. That is, the fiber amplifier 3 performs amplification while causing nonlinear effects with a normal dispersion double-clad fiber without stretching, thereby obtaining ultra-short pulse light L as broadband amplified light. The normal dispersion fiber is a fiber in a state where the dispersion parameter D (ps/nm/km) is negative. The additive used in the fiber amplifier 3 is not particularly limited, and various additives may be employed.

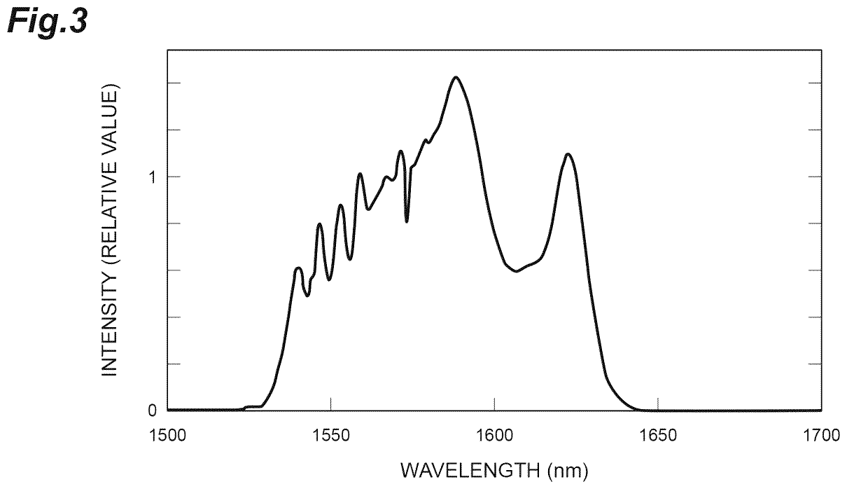

As shown in FIG. 2(c) and 2(d), the fiber amplifier 3 broadens the spectral width of the ultra-short pulse light L to a second spectral width H2, which is wider than the first spectral width H1. The fiber amplifier 3 increases the intensity of the ultra-short pulse light L to a second intensity K2, which is higher than the first intensity K1. Specifically, as shown in FIG. 3, the fiber amplifier 3 sets the spectral width of the ultra-short pulse light L to 100 nm or more. In FIG. 3, the horizontal axis represents the wavelength of the ultra-short pulse light L, and the vertical axis represents the relative value with respect to a predetermined intensity of the ultra-short pulse light L.

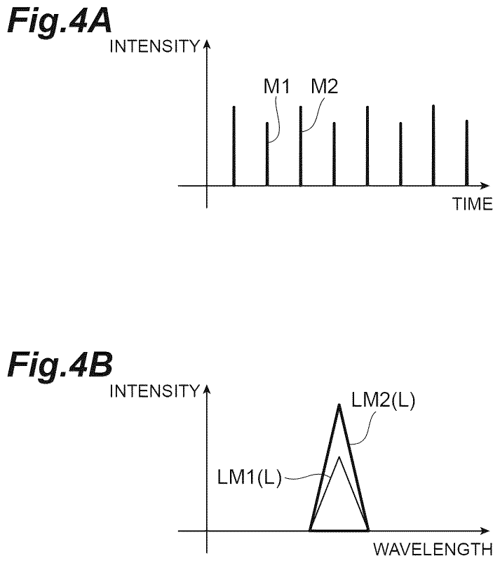

The acousto-optic modulator 4 constitutes an optical intensity control unit that controls the intensity of the ultra-short pulse light L for each pulse. The acousto-optic modulator 4 is an apparatus that modulates the ultra-short pulse light L using the force of sound (acoustic waves) and is referred to as an AOM (Acousto Optic Modulator). In the present embodiment, the acousto-optic modulator 4 is disposed between the fiber amplifier 3 and the soliton shift fiber 6 in the optical path of the ultra-short pulse light L. The acousto-optic modulator 4 may be disposed at any position between the oscillator 2 and the soliton shift fiber 6. As shown in FIG. 4(a) and 4(b), the acousto-optic modulator 4 controls the intensity of the ultra-short pulse light L to vary for each pulse. For example, as shown in FIG. 4(a), when intensity modulations M1 and M2 are applied, ultra-short pulse lights LM1 and LM2 in accordance with the intensities applied by M1 and M2 are generated, as shown in FIG. 4(b). The intensity modulation range and accuracy of the ultra-short pulse light L (LM1, LM2) depend on the performance of the acousto-optic modulator 4. The intensity of each pulse light in the pulse train of the ultra-short pulse light L can be arbitrarily modulated by the acousto-optic modulator 4.

The compressor 5 constitutes a pulse compression unit that compresses the time width of the pulses of the ultra-short pulse light L. In the present embodiment, the compressor 5 is disposed between the acousto-optic modulator 4 and the soliton shift fiber 6 in the optical path of the ultra-short pulse light L. The compressor 5 may be disposed at any position between the fiber amplifier 3 and the soliton shift fiber 6. The compressor 5 compresses the time width of the ultra-short pulse light L, for example, even when the ultra-short pulse light L is stretched (e.g., stretched by several picoseconds) by the fiber amplifier 3, to output ultra-short pulse light L with a time width with a spread of not greater than a predetermined value (less than 1 picosecond). The compressor 5 is not particularly limited, and various compressors can be used.

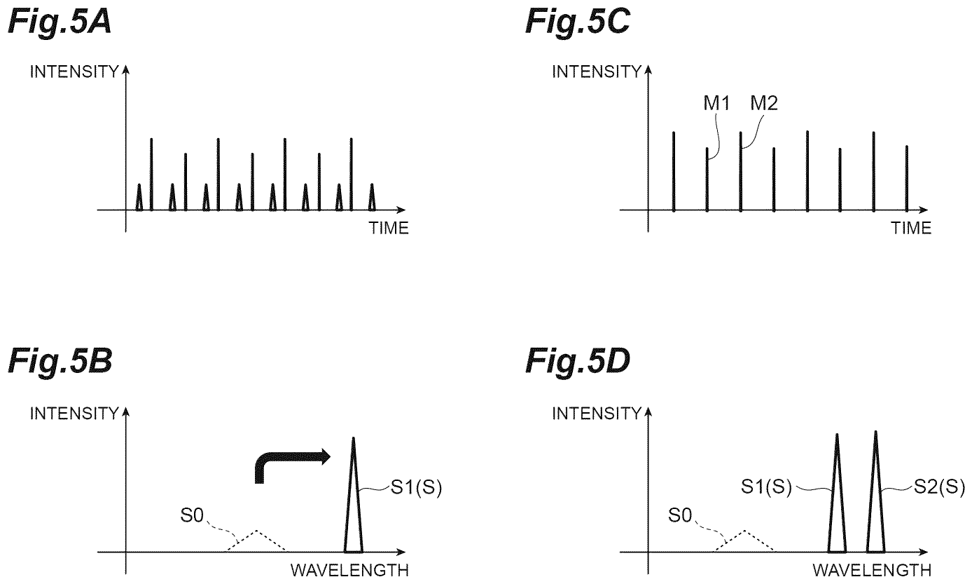

The soliton shift fiber 6 constitutes a modulation unit that modulates the wavelength of the ultra-short pulse light L, which has been broadened in spectrum and increased in output by the fiber amplifier 3, using a soliton self-frequency shift. The soliton shift fiber 6 is disposed downstream of the fiber amplifier 3 in the optical path of the ultra-short pulse light L. As shown in FIG. 5(a) and 5(b), the soliton shift fiber 6 shifts the wavelength of the ultra-short pulse light L to a longer wavelength and generates a soliton S1. The soliton shift fiber 6 can use, for example, a single-mode anomalous dispersion fiber that exhibits anomalous dispersion in the wavelength band of the ultra-short pulse light L generated by the fiber amplifier 3. In addition, by controlling the acousto-optic modulator 4, a soliton with a wavelength different from that of soliton S1 can also be generated. The wavelength of the soliton S, for example, as shown in FIG. 5(c), when intensity modulations M1 and M2 are applied, shifts to a wavelength corresponding to the applied intensities M1 and M2, as shown in FIG. 5(d) (solitons S1 and S2). The shift wavelength range and accuracy of the soliton S depend on the performance of the acousto-optic modulator 4. The shift wavelength of each soliton S in the soliton train generated from the pulse train of the ultra-short pulse light L can be arbitrarily changed by applying intensity modulation to the pulse train using the acousto-optic modulator 4. In the illustrated example, the ultra-short pulse light L modulated by the soliton self-frequency shift includes a non-soliton component SO (a component that did not become soliton S1 or S2).

A filter (not shown) filters the ultra-short pulse light L whose wavelength has been modulated by the soliton shift fiber 6. The filter is disposed downstream of the soliton shift fiber 6 in the optical path of the ultra-short pulse light L. In the illustrated example, as shown in FIG. 5(b) and 5(d), the filter cuts the non-soliton component SO of the ultra-short pulse light L. The filter preferably has an OD value of 3 or more. The filter is not particularly limited, and various filters can be used.

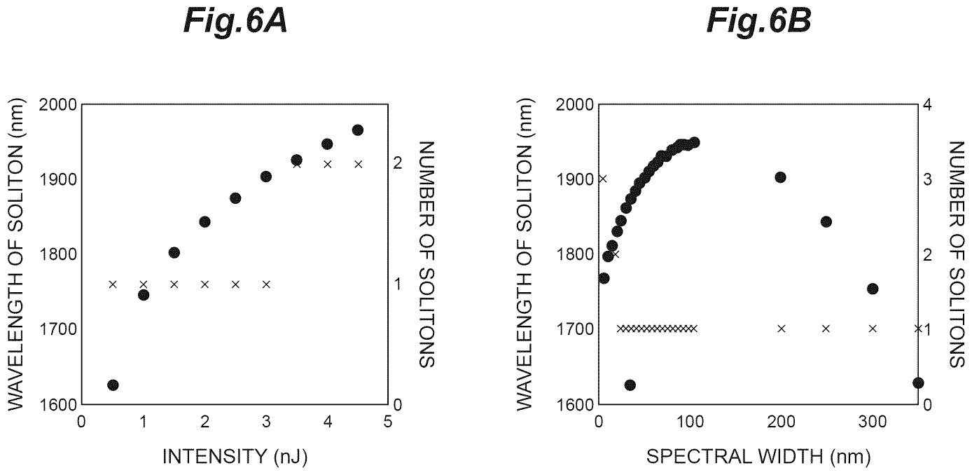

The reason for broadening the spectrum by the fiber amplifier 3 before the soliton shift fiber 6 will be explained. FIG. 6(a) is a graph showing the relationship between the intensity of the ultra-short pulse light L input to the soliton shift fiber 6, the wavelength of solitons, and the number of solitons. FIG. 6(b) is a graph showing the relationship between the special width of the ultra-short pulse light L input to the soliton shift fiber 6, the wavelength of solitons, and the number of solitons. As shown in FIG. 6(a), when the intensity of the ultra-short pulse light L input to the soliton shift fiber 6 is increased, the wavelength of the soliton generated by the soliton self-frequency shift is shifted to a longer wavelength. In this case, it is considered that the tunable wavelength range of the ultra-short pulse light L is expanded. On the other hand, if the intensity of the ultra-short pulse light L input to the soliton shift fiber 6 is too high, a phenomenon called multi-solitonization occurs, and it is considered that the number of solitons becomes plural. Multi-solitonization is, for example, preferably suppressed from a practical viewpoint. Therefore, the inventors conducted further intensive studies and found, as shown in FIG. 6(b), that multi-solitonization can be suppressed by broadening the spectral width of the ultra-short pulse light L input to the soliton shift fiber 6, that is, by broadening the spectrum of the ultra-short pulse light L before performing modulation using the soliton self-frequency shift. Therefore, by broadening the spectrum of the ultra-short pulse light L using the fiber amplifier 3 and modulating the wavelength of the broadened ultra-short pulse light L using the soliton self-frequency shift, it is possible to efficiently shift the wavelength of the soliton to a longer wavelength by increasing the intensity of the ultra-short pulse light L input to the soliton shift fiber 6, while expanding the tunable wavelength range, and suppress multi-solitonization.

Returning to FIG. 1, the stretcher fiber 7 is a stretcher that broadens the time width of the ultra-short pulse light L. The wavelength band of the ultra-short pulse light L whose time width is broadened by the stretcher fiber 7 is, for example, 1800 nm to 2000 nm. The stretcher fiber 7 is configured by combining a first fiber that broadens the time width of the ultra-short pulse light L with a first characteristic and a second fiber that broadens the time width of the ultra-short pulse light L with a second characteristic different from that of the first fiber. The first fiber and the second fiber are configured to broaden the time width of the ultra-short pulse light L by causing differences in the optical path length of each wavelength due to differences in the refractive index of each wavelength when the ultra-short pulse light L passes through. The first fiber broadens the time width of the ultra-short pulse light L in, for example, a wavelength band of 1800 nm to 2000 nm output from the soliton shift fiber 6, with the first characteristic and outputs it to the second fiber. The first fiber may be, for example, a normal dispersion fiber. The second fiber is connected to the first fiber, broadens the time width of the ultra-short pulse light L input from the first fiber with the second characteristic, and outputs it to the fiber amplifier 8. The second fiber may be, for example, a normal dispersion fiber or an anomalous dispersion fiber.

The fiber amplifier 8 amplifies (increases the output of) the ultra-short pulse light L modulated by the soliton shift fiber 6 and broadened in time width by the stretcher fiber 7. The fiber amplifier 8 includes a fiber amplifier. The fiber amplifier of the fiber amplifier 8 is an anomalous dispersion fiber, for example, a thulium-doped fiber. The laser medium added to the fiber of the fiber amplifier 8 is not particularly limited and may be a rare earth such as ytterbium, erbium, or neodymium, or Bi, for example. The wavelength band of the ultra-short pulse light L amplified by the fiber amplifier 8 is, for example, 1800 nm to 2000 nm. The fiber amplifier 8 capable of reliably amplifying the ultra-short pulse light L in a broadband wavelength band may be configured, for example, to include a first fiber amplifier (not shown) having a high gain G1 (not shown) on the shorter wavelength side of the ultra-short pulse light L, which is the first wavelength side, and a second fiber amplifier (not shown) having a high gain G2 (not shown) on the second wavelength side, which is the longer wavelength side, with a filter that attenuates amplified light of the noise caused by ASE and soliton self-frequency shift combined between these amplifiers.

The organic crystal 9 constitutes a terahertz wave generation unit and generates a terahertz wave by being irradiated with the ultra-short pulse light L modulated by the soliton shift fiber 6 and amplified by the fiber amplifier 8. The organic crystal 9 may be configured to include at least one of DAST (4-N,N-dimethylamino-4′-N′-methylstilbazolium tosylate), DASC (4-dimethylamino-N-methyl-4-stilbazolium p-chlorobenzenesulfonate), and DSTMS (4-N,N-dimethylamino-4′-N′-methyl-stilbazolium 2,4,6-trimethylbenzenesulfonate). In the present embodiment, it is described that the organic crystal 9 is configured to include DAST. The organic crystal 9 may generate a terahertz wave with a frequency in the range of 0.01 to 30 THz or may generate a terahertz wave with a frequency in the range of 0.1 to 10 THz. Such a frequency range exhibits high absorption specific to the terahertz wave band and is suitable for spectroscopy. The beam energy of the ultra-short pulse light L irradiated to the organic crystal 9 may be determined in consideration of the damage density of the organic crystal 9.

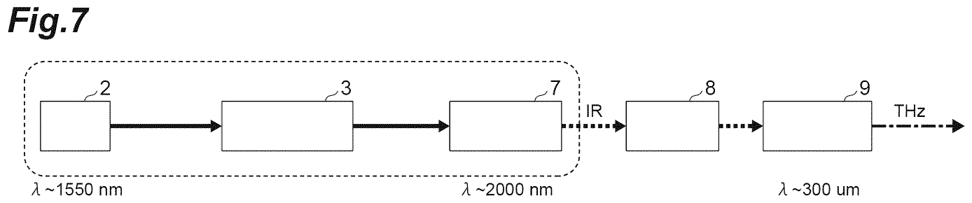

FIG. 7 is a diagram explaining terahertz wave generation. In FIG. 7, some components are omitted for clarity. As shown in FIG. 7, ultra-short pulse light L in, for example, a wavelength band of 1550 nm or less is oscillated from the oscillator 2, the spectrum of the ultra-short pulse light L is broadened by the fiber amplifier 3, the wavelength of the broadened ultra-short pulse light L is modulated using a soliton self-frequency shift in the soliton shift fiber 6, the time width of the ultra-short pulse light L is broadened by the stretcher fiber 7, and the ultra-short pulse light L is amplified by the fiber amplifier 8. Then, by irradiating the organic crystal 9 with the ultra-short pulse light L output from the fiber amplifier 8, a terahertz wave in, for example, a wavelength band of 300 μm or less is generated.

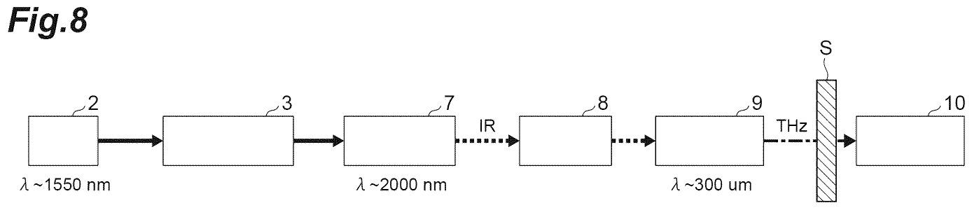

As shown in FIGS. 1 and 8, the terahertz wave generated by the organic crystal 9 is detected by the detection unit 10. The detection unit 10 functions as a terahertz wave detection unit that detects the terahertz wave output from the organic crystal 9. The detection unit 10 may detect a terahertz wave that has passed through a sample S. The detection unit 10 may be, for example, a photomultiplier tube having sensitivity in the band of light including the terahertz wave, an image intensifier that converts the terahertz wave to electrons to acquire an image, a pyroelectric detector, a Golay cell, a Schottky barrier diode, a Fermi level barrier diode, or the like.

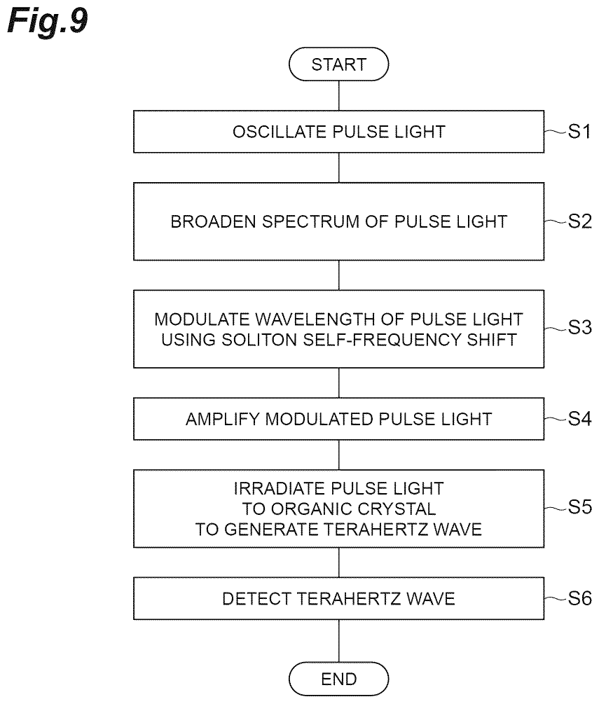

FIG. 9 is a flowchart showing an example of a terahertz wave generation and detection method. As shown in FIG. 9, first, ultra-short pulse light L is oscillated from the oscillator 2 (step S1). Next, the spectrum of the ultra short pulse light L is broadened by the fiber amplifier 3 (step S2).

Next, the ultra-short pulse light L is modulated using a soliton self-frequency shift in the soliton shift fiber 6 (step S3), the time width of the ultra-short pulse light L is broadened by the stretcher fiber 7, and the ultra-short pulse light L is amplified by the fiber amplifier 8 (step S4).

Then, the ultra-short pulse light L output from the fiber amplifier 8 is irradiated to the organic crystal 9 to generate a terahertz wave (step S5), and the terahertz wave is detected by the detection unit 10 (step S6).

Next, the effects of the terahertz wave generation apparatus 1 according to the present embodiment will be described.

The terahertz wave generation apparatus 1 includes an oscillator 2 that oscillates ultra-short pulse light L, a fiber amplifier 3 that broadens the spectrum of the ultra-short pulse light L oscillated by the oscillator 2, a soliton shift fiber 6 that modulates the wavelength of the ultra-short pulse light L, the spectrum of which has been broadened by the fiber amplifier 3, using a soliton self-frequency shift, and an organic crystal 9 that generates a terahertz wave by being irradiated with the ultra-short pulse light L modulated by the soliton shift fiber 6.

As a result of intensive studies, the inventors have found that multi-solitonization can be suppressed by broadening the spectrum of the ultra-short pulse light before performing modulation using a soliton self-frequency shift. Therefore, in the terahertz wave generation apparatus 1, the spectrum of the ultra-short pulse light L is broadened, and the wavelength of the broadened ultra-short pulse light L is modulated using a soliton self-frequency shift. This makes it possible to suppress multi-solitonization even when, for example, the intensity of the ultra-short pulse light L before modulation is increased. By irradiating the organic crystal 9 with the ultra-short pulse light L in which multi-solitonization is suppressed, a terahertz wave can be generated without causing pulse splitting. This enables the generation of a terahertz wave with high efficiency.

As described above, in the terahertz wave generation apparatus 1 according to the present embodiment, an organic crystal 9 is employed as the terahertz wave generation unit. With such a configuration, it is possible to generate a terahertz wave with higher efficiency.

The terahertz wave generation unit may be configured to include at least one of DAST, DASC, and DSTMS as the organic crystal 9. With such a configuration, it is possible to generate a terahertz wave with higher efficiency.

The organic crystal 9 may generate a terahertz wave with a frequency in the range of 0.01 to 30 THz. By being set to such a frequency band, absorption specific to terahertz waves increases, enabling appropriate spectroscopy.

The terahertz wave generation apparatus 1 may further include a fiber amplifier 8 configured to include a thulium-doped fiber amplifier that amplifies the ultra-short pulse light L modulated by the soliton shift fiber 6, wherein the organic crystal 9 generates a terahertz wave by being irradiated with the ultra-short pulse light L modulated by the soliton shift fiber 6 and amplified by the fiber amplifier 8. By irradiating the organic crystal 9 with the ultra-short pulse light L amplified by the fiber amplifier 8, it is possible to generate a terahertz wave with higher efficiency.

The terahertz wave generation apparatus 1 may further include a detection unit 10 that detects the terahertz wave output from the organic crystal 9. By providing the detection unit 10 in the terahertz wave generation apparatus 1, the terahertz wave generated with high efficiency can be detected easily and quickly.

The above-described one aspect of the present disclosure is not limited to the above embodiment.

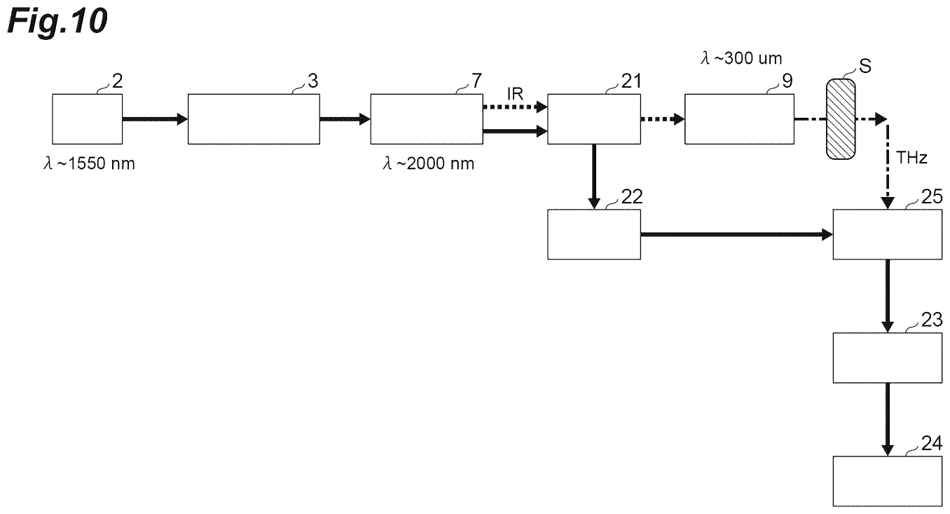

FIG. 10 is a diagram explaining terahertz wave detection according to a modification. The terahertz wave generation apparatus shown in FIG. 10 obtains the complex refractive index of a sample S using terahertz waves by terahertz time-domain spectroscopy. The terahertz wave generation apparatus shown in FIG. 10 includes, in addition to the oscillator 2, fiber amplifier 3, acousto-optic modulator (not shown), compressor (not shown), soliton shift fiber (not shown), stretcher fiber 7, organic crystal 9, and the like described above, an optical branching unit 21, an optical path delay unit 22, a terahertz wave detection crystal 25, a polarization adjustment unit 23, and an optical detection unit 24.

The optical branching unit 21 branches the ultra-short pulse light L modulated by the soliton shift fiber into pump light with which the organic crystal 9 is irradiated and probe light. The optical branching unit 21 may be configured, for example, by a beam splitter or the like. A terahertz wave is generated by irradiating the organic crystal 9 with the pump light. The terahertz wave may be irradiated to a sample S that is insertable and removable. By using, for example, a residual light component in a wavelength band of 1550 nm that did not contribute to terahertz wave generation as probe light for terahertz wave detection, light can be utilized without waste. Furthermore, since an optical detector for a wavelength of 2000 nm is expensive, but an optical detector for 1550 nm is relatively inexpensive, costs can be reduced.

The optical path delay unit 22 is configured to time-delay the probe light by changing the optical path length of the probe light. The optical path delay unit 22 may include, for example, a mechanical stage or the like.

The terahertz wave detection crystal 25 is a crystal for terahertz wave detection into which the pump light with which the sample S (or the pump light that arrived without being irradiated to the sample S) is irradiated and the probe light that has passed through the optical path delay unit 22 are incident.

Here, since the terahertz wave exists only for an extremely short period, waveform observation is not easy. Therefore, a method (terahertz time-domain spectroscopy) is employed in which the terahertz wave is repeatedly generated, and the probe light is time-delayed by placing the optical path delay unit 22 on the probe light side to change the optical path length, observing the waveform while slightly shifting the detection timing.

Terahertz time-domain spectroscopy is performed, for example, by the following procedure. First, a pulse laser with, for example, a wavelength of about 1.5 μm is incident on the terahertz wave detection crystal 25 and enters the optical detection unit 24 via the polarization adjustment unit 23. At this time, the angle of the polarization adjustment unit 23 (e.g., a polarizer) is adjusted so that the light intensity after passing through the polarization adjustment unit 23 is minimized.

First, in a state where the sample S is not present in the optical path, the generated terahertz wave and the probe light are spatially and temporally overlapped and incident on the terahertz wave detection crystal 25. Then, by adjusting the optical path delay unit 22, the time delay of the probe light and the signal output from the optical detection unit 24 are measured, and the terahertz waveform is acquired.

Next, in a state where the sample S is present in the optical path, by adjusting the optical path delay unit 22, the time delay of the probe light and the signal output from the optical detection unit 24 are measured, and the terahertz waveform that has passed through the sample S is acquired.

Finally, the terahertz waveforms for the cases where the sample S is present and not present in the optical path are Fourier-transformed, and the complex refractive index of the sample S is derived from the difference in amplitude and phase. This allows the state of the sample S to be specified.

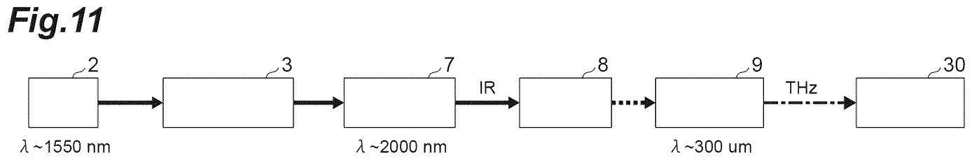

FIG. 11 is a diagram explaining terahertz wave detection according to another modification. The terahertz wave generation apparatus shown in FIG. 11 includes, in addition to the oscillator 2, fiber amplifier 3, acousto-optic modulator (not shown), compressor (not shown), soliton shift fiber (not shown), stretcher fiber 7, fiber amplifier 8, organic crystal 9, and the like described above, a terahertz measurement unit 30. The terahertz measurement unit 30 is configured to measure the terahertz wave output from the organic crystal 9.

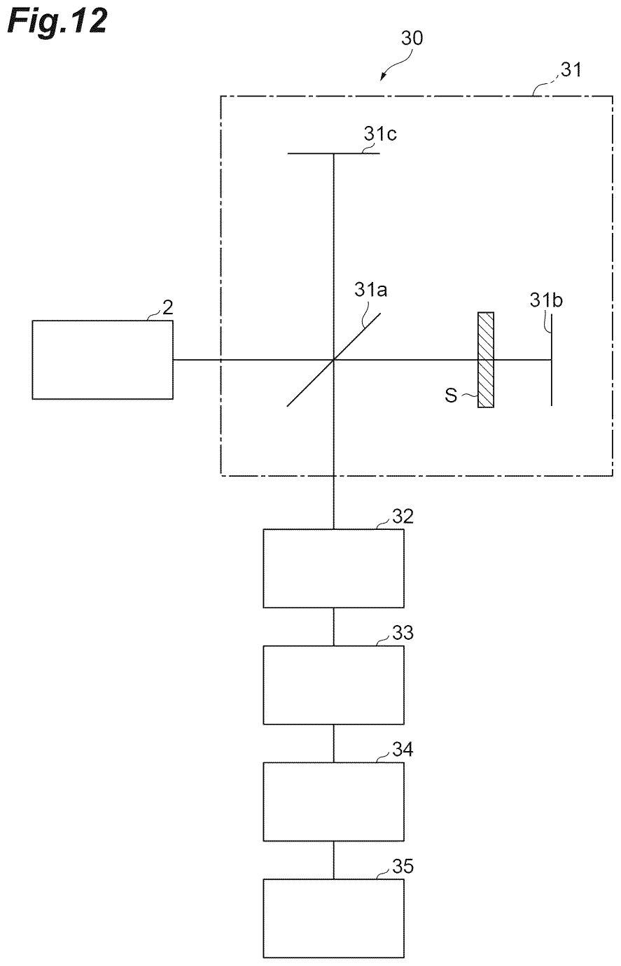

FIG. 12 is a diagram showing an example of the configuration of the terahertz measurement unit 30. As shown in FIG. 12, the terahertz measurement unit 30 includes an interference optical system 31, a photomultiplier tube 32, an interference intensity measurement unit 33, an electric field amplitude calculation unit 34, and an analysis unit 35.

The interference optical system 31 includes a beam splitter 31a, a mirror 31b, and a mirror 31c, and has the configuration of a Michelson interferometer. The beam splitter 31a splits the light output from the oscillator 2 into a first branched light and a second branched light, outputs the first branched light to the mirror 31b, and outputs the second branched light to the mirror 31c. The beam splitter 31a receives the first branched light reflected by the mirror 31b and the second branched light reflected by the mirror 31c, combines the received first branched light and second branched light, and outputs them to the photomultiplier tube 32. The beam splitter 31a may be configured, for example, by silicon or an ITO mirror. The sample S is disposed on the optical path of the first branched light between the beam splitter 31a and the mirror 31b. The sample S may be disposed on the optical path of the second branched light. Both or either one of the mirror 31b and the mirror 31c can move in a direction perpendicular to the reflection surface, thereby making the optical path length difference between the first branched light and the second branched light variable.

The photomultiplier tube 32 has sensitivity in the band of light including the terahertz wave and outputs an electrical signal with a value corresponding to the incident light intensity. The interference intensity measurement unit 33 measures the intensity of the interference light by the first branched light and the second branched light incident on the photomultiplier tube 32 based on the electrical signal output from the photomultiplier tube 32.

The electric field amplitude calculation unit 34 converts the intensity V of the interference light measured by the interference intensity measurement unit 33 into the value of the electric field amplitude E based on the relationship between the value of the electric field amplitude of the light incident on the photomultiplier tube 32 and the value of the electrical signal output from the photomultiplier tube 32, and obtains the value of the electric field amplitude E of the interference light for each value of the time difference Δt corresponding to the optical path length difference Δd. The optical path length difference Δd corresponds to twice the difference in distance from the beam splitter to each of the two mirrors. The relationship between the optical path length difference Δd and the time difference Δt is given by Δt=Δd/c. Here, c is the speed of light in a vacuum.

The analysis unit 35 performs analysis of the sample S by performing a Fourier transform based on the dependence of the value of the electric field amplitude E of the interference light obtained by the electric field amplitude calculation unit 34 on the value of the time difference Δt.

With such a configuration, the interference time waveform and spectrum of the terahertz wave generated efficiently can be measured quickly and efficiently.

The terahertz measurement unit may be configured to include an image intensifier that converts the terahertz wave to electrons to acquire an image. With such a configuration, the two-dimensional image of the interference time waveform and spectrum of the terahertz wave generated efficiently can be measured quickly and efficiently.

### REFERENCE SIGNS LIST

1 Terahertz wave generation apparatus, 2 Oscillator (oscillation unit), 3 Fiber amplifier (first amplification unit), 6 Soliton shift fiber (modulation unit), 8 Fiber amplifier (second amplification unit), 9 Organic crystal (terahertz wave generation unit), 10 Detection unit (terahertz wave detection unit), 21 Optical branching unit, 22 Optical path delay unit, 25 Terahertz wave detection crystal, 32 Photomultiplier tube, L Ultra-short pulse light (pulse light), S Sample

What is claimed is:

1. A terahertz wave generation apparatus comprising:
an oscillation unit configured to oscillate pulse light;
a first amplification unit configured to broaden the spectrum of the pulse light oscillated by the oscillation unit;
a modulation unit configured to modulate the wavelength of the pulse light, the spectrum of which has been broadened by the first amplification unit, using a soliton self-frequency shift; and
a terahertz wave generation unit configured to generate a terahertz wave by being irradiated with the pulse light modulated by the modulation unit.

2. The terahertz wave generation apparatus according to claim 1, wherein the terahertz wave generation unit is configured to include an organic crystal.

3. The terahertz wave generation apparatus according to claim 2, wherein the terahertz wave generation unit is configured to include at least one of DAST, DASC, and DSTMS as the organic crystal.

4. The terahertz wave generation apparatus according to claim 1, wherein the terahertz wave generation unit generates the terahertz wave having a frequency in the range of 0.01 to 30 THz.

5. The terahertz wave generation apparatus according to claim 1, further comprising a second amplification unit configured to include a thulium-doped fiber amplifier configured to amplify the pulse light modulated by the modulation unit,
wherein the terahertz wave generation unit generates the terahertz wave by being irradiated with the pulse light modulated by the modulation unit and amplified by the second amplification unit.

6. The terahertz wave generation apparatus according to claim 1, further comprising a terahertz wave detection unit configured to detect the terahertz wave output from the terahertz wave generation unit.

7. The terahertz wave generation apparatus according to claim 1, further comprising:
an optical branching unit configured to branch the pulse light modulated by the modulation unit into pump light with which the terahertz wave generation unit is irradiated and probe light;
an optical path delay unit that time-delays the probe light by changing the optical path length of the probe light; and
a terahertz wave detection crystal into which the pump light with which a sample is irradiated and the probe light that has passed through the optical path delay unit are incident.

8. The terahertz wave generation apparatus according to claim 1, further comprising a terahertz wave measurement unit configured to measure the terahertz wave output from the terahertz wave generation unit,
wherein the terahertz wave measurement unit is configured to include a photomultiplier tube having sensitivity in the band of light including the terahertz wave.

9. The terahertz wave generation apparatus according to claim 1, further comprising a terahertz wave measurement unit that measures the terahertz wave output from the terahertz wave generation unit,
wherein the terahertz wave measurement unit is configured to include an image intensifier that converts the terahertz wave to electrons to acquire an image.

10. A terahertz wave generation method comprising:
oscillating pulse light;
broadening the spectrum of the pulse light;
modulating the wavelength of the broadened pulse light using a soliton self-frequency shift; and
generating a terahertz wave by irradiating an organic crystal with the modulated pulse light.
